(19) United States
(12) Patent Application Publication
(10) Pub. No.: US 2017/0077999 A1
(43) Pub. Date: Mar. 16, 2017

(54) ACCESS POINT-CONTROLLED RESPONSES TO UPLINK MULTI-USER FRAMES

(71) Applicant: QUALCOMM Incorporated, San Diego, CA (US)

(72) Inventors: Alfred ASTERJADHI, San Diego, CA (US); Simone MERLIN, San Diego, CA (US); George CHERIAN, San Diego, CA (US); Gwendolyn Denise BARRIAC, Encinitas, CA (US); Yan ZHOU, San Diego, CA (US); Gang DING, San Diego, CA (US)

(21) Appl. No.: 15/260,186

(22) Filed: Sep. 8, 2016

Related U.S. Application Data
(60) Provisional application No. 62/216,973, filed on Sep. 10, 2015.

(51) Int. Cl. H04B 7/02; H04W 72/00; H04W 72/04; H04L 1/16; H04W 52/02

(52) U.S. Cl. CPC H04B 7/024; H04L 1/1621; H04W 52/0248; H04W 72/0413; H04W 72/0446; H04W 72/005

(57) ABSTRACT

A method, an apparatus, and a computer-readable medium for wireless communication are provided. In an aspect, an apparatus may be configured to transmit a first frame that includes a delay indicator. The apparatus may be configured to receive a second frame from a station based on the transmitted first frame. The apparatus may be configured to determine when to transmit a third frame based on the received second frame. In this aspect, the delay indicator may indicate whether the access point will delay transmitting the third frame after receiving the second frame during multi-user uplink operation.

### CROSS-REFERENCE TO RELATED APPLICATION(S)

This application claims the benefit of U.S. Provisional Application Ser. No. 62/216,973, entitled “ACCESS POINT-CONTROLLED RESPONSES TO UPLINK MULTI-USER FRAMES” and filed on Sep. 10, 2015, which is expressly incorporated by reference herein in its entirety.

### BACKGROUND

Field

The present disclosure relates generally to communication systems, and more particularly, to access point-controlled responses to uplink multi-user (MU) frames.

Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

One aspect of this disclosure provides an apparatus (e.g., an access point) for wireless communication. The apparatus is configured to transmit a first frame that includes a delay indicator. The apparatus is configured to receive a second frame based on the transmitted first frame. The apparatus is configured to determine when to transmit a third frame based on the received second frame. The delay indicator may indicate whether the apparatus will delay transmitting the third frame after receiving the second frame during multi-user uplink operation.

In another aspect of this disclosure, an access point for wireless communication is provided. The access point may include means for transmitting a first frame that includes a delay indicator. The access point may include means for receiving a second frame from a station based on the transmitted first frame and means for determining when to transmit a third frame based on the received second frame. The delay indicator may indicate whether the access point will delay transmitting the third frame after receiving the second frame during multi-user uplink operation. In an aspect, the delay indicator may be a bit indicator that indicates when the access point will transmit the third frame. In another aspect, the delay indicator may indicate whether the access point will transmit the third frame within an interframe space after receiving the second frame. In another aspect, the delay indicator may indicate whether the access point will transmit the third frame at an end of a transmit opportunity for multi-user uplink transmissions for a plurality of stations. In another aspect, the first frame may be a trigger frame, the second frame may be an uplink frame, and the third frame may be a multi-station block acknowledgment frame. In another configuration, the access point may include means for receiving a plurality of frames from a plurality of stations, means for accumulating acknowledgment information associated with the plurality of frames from the plurality of stations and with the second frame from the station, and means for transmitting the third frame based on the determination of when to transmit the third frame. The third frame may include the accumulated acknowledgment information and the determination may be further based on the received plurality of frames.

In another aspect of this disclosure, a computer-readable medium of an access point storing computer executable code is provided. The computer-readable medium may include code to transmit a first frame that includes a delay indicator. The computer-readable medium may include code to receive a second frame from a station based on the transmitted first frame and code to determine when to transmit a third frame based on the received second frame. The delay indicator may indicate whether the access point will delay transmitting the third frame after receiving the second frame during multi-user uplink operation. In an aspect, the delay indicator may be a bit indicator that indicates when the access point will transmit the third frame. In another aspect, the delay indicator may indicate whether the access point will transmit the third frame within an interframe space after receiving the second frame. In another aspect, the delay indicator may indicate whether the access point will transmit the third frame at an end of a transmit opportunity for multi-user uplink transmissions for a plurality of stations. In another aspect, the first frame may be a trigger frame, the second frame may be an uplink frame, and the third frame may be a multi-station block acknowledgment frame. In another configuration, the computer-readable medium may include code to receive a plurality of frames from a plurality of stations, code to accumulate acknowledgment information associated with the plurality of frames from the plurality of stations and with the second frame from the station, and code to transmit the third frame based on the determination of when to transmit the third frame. The third frame may include the accumulated acknowledgment information and the determination may be further based on the received plurality of frames.

Another aspect of this disclosure provides a wireless device (e.g., a station) for wireless communication. The apparatus is configured to receive a first frame from an access point that comprises a delay indicator. The apparatus is configured to transmit a second frame based on the received first frame. The apparatus is configured to determine when the access point will transmit a third frame in response to the transmitted second frame. The delay indicator may indicate whether the access point will delay transmitting the third frame after receiving the second frame during multi-user uplink operation.

In another aspect of this disclosure, a station for wireless communication is provided. The station may include means for receiving a first frame from an access point that includes a delay indicator. The station may include means for transmitting a second frame based on the received first frame. The station may include means for determining when the access point will transmit a third frame in response to the transmitted second frame. The delay indicator may indicate whether the access point will delay transmitting the third frame after receiving the second frame during multi-user uplink operation. In an aspect, the delay indicator may be a bit indicator that indicates when the access point will transmit the third frame. In another aspect, the delay indicator may indicate whether the access point will transmit the third frame within an interframe space after receiving the second frame. In another aspect, the delay indicator may indicate whether the access point will transmit the third frame at an end of a transmit opportunity for multi-user uplink transmissions for a plurality of stations. In another configuration, the station may include means for determining a sleep interval associated with the station based on the delay indicator. In an aspect, the means for determining the sleep interval may be configured to determine a transmit opportunity time duration associated with multi-user uplink transmissions and to determine a multi-station block acknowledgement time duration. The sleep interval may be based on the transmit opportunity time duration, the multi-station block acknowledgment time duration, and an interframe space time duration. In another aspect, the first frame may be a trigger frame, the second frame may be an uplink frame, and the third frame may be a multi-station block acknowledgment frame.

In another aspect of this disclosure, a computer-readable medium of a station storing computer executable code is provided. The computer-readable medium may include code to receive a first frame from an access point that includes a delay indicator. The computer-readable medium may include code to transmit a second frame based on the received first frame. The computer-readable medium may include code to determine when the access point will transmit a third frame in response to the transmitted second frame. The delay indicator may indicate whether the access point will delay transmitting the third frame after receiving the second frame during multi-user uplink operation. In an aspect, the delay indicator may be a bit indicator that indicates when the access point will transmit the third frame. In another aspect, the delay indicator may indicate whether the access point will transmit the third frame within an interframe space after receiving the second frame. In another aspect, the delay indicator may indicate whether the access point will transmit the third frame at an end of a transmit opportunity for multi-user uplink transmissions for a plurality of stations. In another configuration, the computer-readable medium may include code to determine a sleep interval associated with the station based on the delay indicator. In an aspect, the code to determine the sleep interval may include code to determine a transmit opportunity time duration associated with multi-user uplink transmissions and to determine a multi-station block acknowledgement time duration. The sleep interval may be based on the transmit opportunity time duration, the multi-station block acknowledgment time duration, and an interframe space time duration. In another aspect, the first frame may be a trigger frame, the second frame may be an uplink frame, and the third frame may be a multi-station block acknowledgment frame.

### BRIEF DESCRIPTION OF THE DRAWINGS

FIG. 1 shows an example wireless communication system in which aspects of the present disclosure may be employed.

FIG. 2 is an exemplary diagram of a method for controlling responses to uplink multi-user frames.

FIG. 3 illustrates exemplary diagrams of a trigger frame that indicates whether a control response frame is to be delayed, an uplink frame, and a multi-station block acknowledgment frame.

FIG. 4 is a functional block diagram of a wireless device that may be employed within the wireless communication system of FIG. 1 to control responses to uplink multi-user frames.

FIG. 5 is a flowchart of an exemplary method of wireless communication for controlling responses to uplink multi-user frames.

FIG. 6 is a functional block diagram of an exemplary wireless communication device that controls responses to uplink multi-user frames.

FIG. 7 is a functional block diagram of a wireless device that may be employed within the wireless communication system of FIG. 1 that supports controlled responses to uplink multi-user frames.

FIG. 8 is a flowchart of an example method of wireless communication for transmitting dedicated single stream pilot for phase tracking.

FIG. 9 is a functional block diagram of an exemplary wireless communication device that supports controlled responses to uplink multi-user frames.

### DETAILED DESCRIPTION

Various aspects of the novel systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A STA may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a STA may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

In an aspect, MIMO schemes may be used for wide area WLAN (e.g., Wi-Fi) connectivity. MIMO exploits a radio-wave characteristic called multipath. In multipath, transmitted data may bounce off objects (e.g., walls, doors, furniture), reaching the receiving antenna multiple times through different routes and at different times. A WLAN device that employs MIMO will split a data stream into multiple parts, called spatial streams, and transmit each spatial stream through separate antennas to corresponding antennas on a receiving WLAN device.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

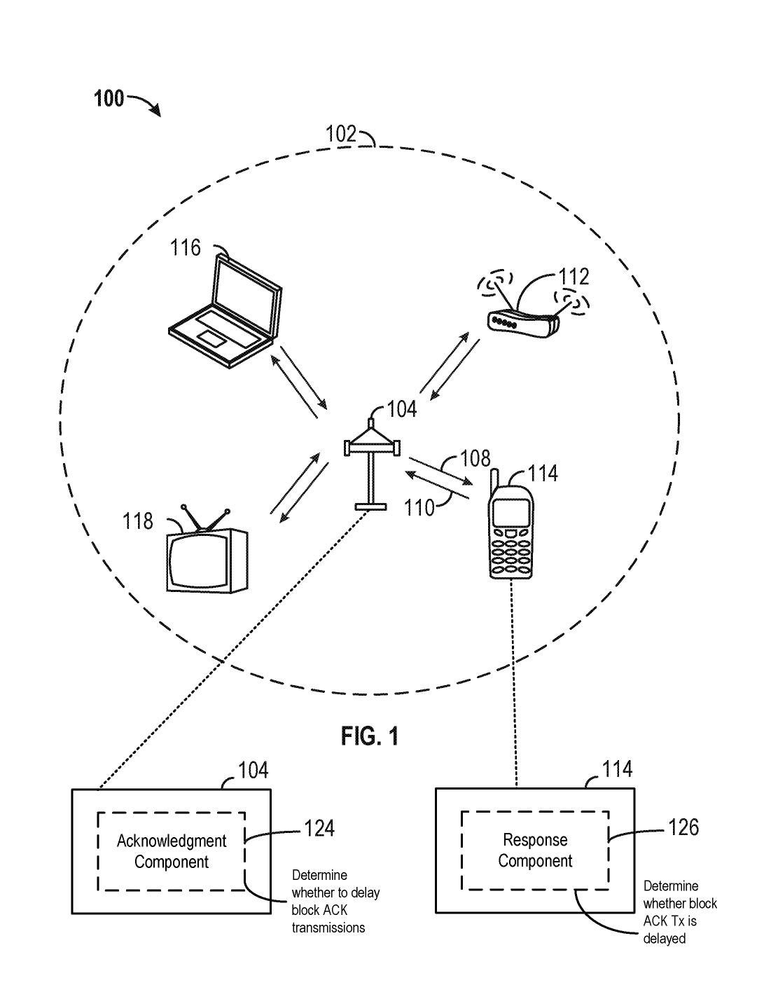

FIG. 1 shows an example wireless communication system 100 in which aspects of the present disclosure may be employed. The wireless communication system 100 may operate pursuant to a wireless standard, for example the 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system.

Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the AP 104 may include one or more components for performing various functions. For example, the AP 104 may include an acknowledgment component 124 configured to perform procedures related to controlling responses to uplink multi-user frames. In this example, the acknowledgment component 124 may be configured to transmit a first frame that includes a delay indicator, to receive a second frame based on the transmitted first frame, and to determine when to transmit a third frame based on the received second frame. The delay indicator may indicate whether the AP 104 will delay transmitting the third frame after receiving the second frame during multi-user uplink operation.

In another aspect, the STA 114 may include one or more components for performing various functions. For example, the STA 114 may include a response component 126 configured to perform procedures related to controlled responses to uplink multi-user frames. In this example, the response component 126 may be configured to receive a first frame from an access point that comprises a delay indicator, to transmit a second frame based on the received first frame, and to determine when the access point will transmit a third frame in response to the transmitted second frame. The delay indicator may indicate whether the access point will delay transmitting the third frame after receiving the second frame during multi-user uplink operation.

In a Wi-Fi network, wireless devices such as APs and STAs may use various protocols (e.g., enhanced distributed channel access (EDCA) protocols) to manage wireless traffic. Wireless protocols such as the EDCA protocol may control traffic using a set of parameters: CWMIN (contention window minimum), CWMAX (contention window maximum), AIFSN (arbitration interframe space number), and TXOP (transmit opportunity). In an aspect, CWMIN, the minimum contention window, determines the random amount of time a wireless device (e.g., a STA) may need to back off before the wireless device may transmit data. The random backoff is chosen randomly between 0 and the contention window value. The minimum value the contention window can take is CWMIN. In an aspect, the CWMIN may be similar to a counter. A larger CWMIN value means the wireless device needs to back off (or count) for a longer period of time before attempting to transmit data.

After the backoff period has passed, the wireless device may attempt to transmit data. If the transmission fails, the wireless device may increase the CWMIN value by a factor of 2 (e.g., CWMIN*2). The wireless device may wait for a random time between 0 and CWMIN*2 and attempt to transmit the data again. If the transmission fails again, the wireless device may increase the CWMIN value by another factor of 2 (e.g., CWMIN*4). If the re-transmission fails again, the CWMIN will be further doubled until the new CWMIN value is greater than or equal to CWMAX, at which point CWMIN does not exceed CWMAX (and CWMIN may be set to CWMAX). AIFSN, which stands for arbitration interframe space number, may represent a fixed back off duration that occurs before the random back off. As such, a smaller AIFSN represents a smaller fixed back off. TXOP, or transmit opportunity, represents the data/data packet duration. A longer TXOP increases the air time for data transmission, which enables more data to be transmitted.

The aforementioned parameters, such as TXOP, are important in dense wireless networks. For example, if TXOP is set too low, traffic data throughout may diminish because wireless devices may not have sufficient time to transmit data. If TXOP is set too high, some wireless devices may be starved for time to transmit.

Further, in multi-user TXOP situations, in which a TXOP is shared by multiple stations, the access point may send trigger frames to enable uplink frames to be sent by multiple stations. In an aspect, the trigger frame may be used to solicit uplink frames from one or more STAs, and the frames may be transmitted in multi-user uplink OFDMA or multi-user MIMO. Each station may solicit a response back from the access point to acknowledge receipt of the uplink frames (e.g., an acknowledgment frame). Because the acknowledgment frame to each of the stations may be transmitted within the same TXOP for uplink transmission, having multiple acknowledgment frames may increase overhead and reduce the overall TXOP available for uplink transmission. As such, a need exists to enable the access point to optimally allocate multi-user resources and manage when the control responses to uplink transmissions are sent within a TXOP.

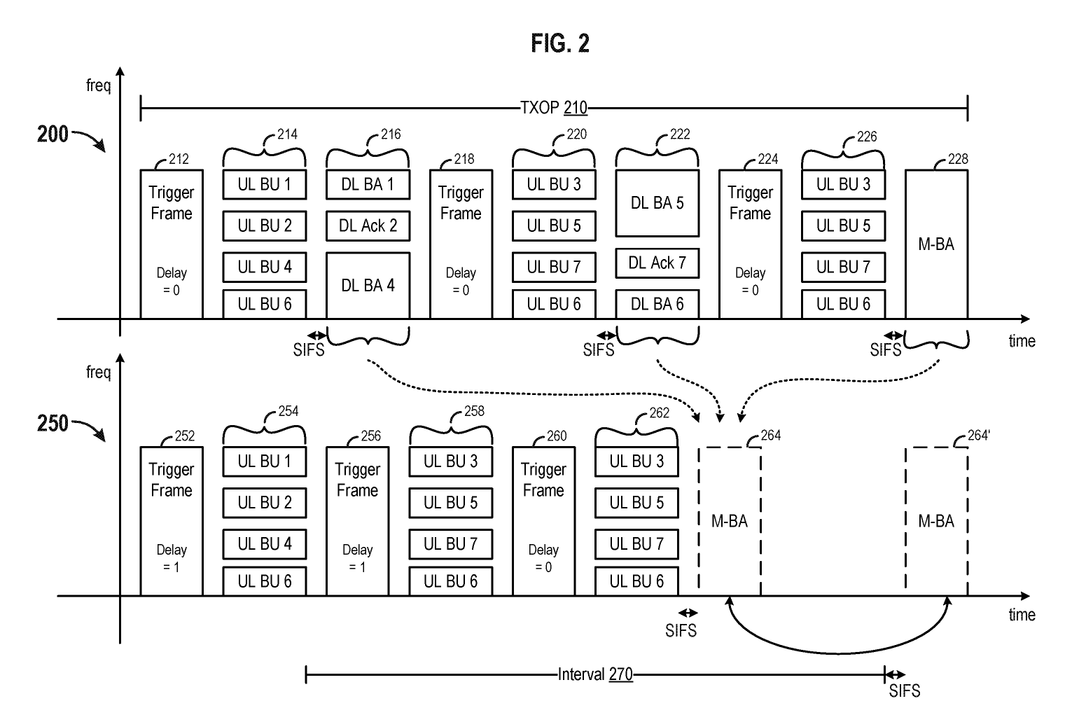

FIG. 2 illustrates exemplary diagrams 200, 250 of a method for controlling responses to uplink multi-user frames. Referring to diagram 200, the AP 104 may be configured to provide centralized control of frame exchanges within a TXOP 210. The AP 104 may serve STAs 1-10 (e.g., the STAs 112, 114, 116, 118 and others) within the BSA 102. In diagram 200, STAs 1, 2, 3, 4, 5, 6, and 7 may have data to transmit to the AP 104 and may send a request to transmit to the AP 104. Upon receiving the requests to transmit from the STAs 1-7, the AP 104 may determine whether to allow the STAs 1-7 to transmit on the uplink and, if so, allocate resources for the STAs 1-7 for uplink transmission. Assuming the AP 104 allows the STAs 1, 2, 4, 6 to transmit, the AP 104 may transmit a first trigger frame 212 to each of the STAs 1, 2, 4, 6. The first trigger frame 212 may indicate resources that have been allocated to each of the STAs 1, 2, 4, 6 for uplink transmission. In an aspect, the first trigger frame 212 may include a first delay indicator, which may be a bit indicator within a delay indication field or any other field of the first trigger frame 212. The first delay indicator may indicate when the AP 104 will transmit a control response to any uplink frame transmitted by the STAs 1, 2, 4, 6. For example, when the first delay indicator is set to 0, the AP 104 may generate a downlink control response frame (e.g., acknowledgment frame) within an interframe space (e.g., short interframe space (SIFS) or distributed coordination function (DCF) interframe space (DIFS)) after receiving an uplink transmission (e.g., an uplink multi-user physical layer convergence procedure (PLCP) protocol data unit (PPDU)). If first delay indicator is set to 1, the AP 104 may transmit the downlink control response frame at the end of the TXOP 210 or after there is no more data to be sent during the TXOP 210. As such, the first delay indicator indicates whether the AP 104 will delay transmitting the downlink control response frame (e.g., transmit at the end of the TXOP 210 for multi-user uplink transmissions) or will not delay transmitting the downlink control response frame (e.g., transmit within a SIFS).

Upon receiving the first trigger frame 212, the STAs 1, 2, 4, 6 may determine the respective uplink resources allocated and transmit a first set of uplink transmissions 214. For example, each of the STAs 1, 2, 4, 6 may transmit an uplink buffered unit (BU) such that the first set of uplink transmissions 214 includes UL BU 1, UL BU 2, UL BU 4, and UL BU 6, corresponding to STAs 1, 2, 4, 6, respectively. Upon receiving the UL BU 1, 2, 4, 6, the AP 104 may determine when to transmit a control response frame (e.g., an acknowledgment frame that may acknowledge one medium access control (MAC) protocol data unit (MPDU) or a block acknowledgment (BA) frame that may acknowledge multiple MPDUs)) to each of the STAs 1, 2, 4, 6. In an aspect, the determination may be based on the first delay indicator. In this example, the first delay indicator may be set to 0, which may indicate that the AP 104 may not delay transmitting the control response frames, and therefore, the AP 104 may transmit control response frames within an interframe space (IFS) (e.g., SIFS) after receiving an uplink frame.

Referring to diagram 200, the AP 104 may transmit a first set of control response frames 216. The first set of control response frames 216 may include a DL BA 1 to STA 1, a DL ACK 2 to STA 2, and a DL BA 4 to STA 4. In this example, the DL BA 1 and the DL ACK 2 may be transmitted on the same frequencies as the UL BU 1 and UL BU 2, respectively. The DL BA 4 may be transmitted on the remaining frequencies within a bandwidth. Alternatively, the DL BA 4 may be transmitted on the same frequencies as UL BU 4. The AP 104 may not transmit a control response frame for the UL BU 6 because the UL BU 6 may not have requested a control response frame from the AP 104.

Continuing with diagram 200, the STAs 1, 2, 4 may no longer have data to transmit, but the STAs 3, 5, 6, 7 may have data to transmit. The AP 104 may transmit a second trigger frame 218 within the TXOP 210 to the STAs 3, 5, 6, 7. In an aspect, the STA 6 may be allocated resources on the same frequencies as indicated in the first trigger frame 212, or the STA 6 may be allocated resources on different frequencies. The second trigger frame 218 may include a second delay indicator set to 0.

Upon receiving the second trigger frame 218, the STAs 3, 5, 6, 7 may transmit a second set of uplink transmissions 220. For example, each of the STAs 3, 5, 6, 7 may transmit an UL BU such that the second set of uplink transmissions 220 includes UL BU 3, UL BU 5, UL BU 7, and UL BU 6, corresponding to STAs 3, 5, 7, 6, respectively. Upon receiving the UL BU 3, 5, 6, 7, the AP 104 may determine when to transmit a control response frame to each of the STAs 3, 5, 6, 7. In an aspect, the determination may be based on the second delay indicator. In this example, the second delay indicator may be set to 0, which may indicate that the AP 104 may not delay transmitting the control response frames, and therefore, the AP 104 may transmit control response frames within a SIFS after receiving an uplink frames.

Referring to diagram 200, the AP 104 may transmit a second set of control response frames 222. The second set of control response frames 222 may include a DL BA 5 to STA 5, a DL ACK 7 to STA 7, and a DL BA 6 to STA 6. In this example, the DL ACK 7 and the DL BA 6 may be transmitted on the same frequencies as the UL BU 7 and UL BU 6, respectively. The DL BA 5 may be transmitted on the remaining frequencies within a bandwidth. Alternatively, the DL BA 5 may be transmitted on the same frequencies as UL BU 5. The AP 104 may not transmit a control response frame for the UL BU 3 because the UL BU 3 may not have requested a control response frame from the AP 104.

Continuing with diagram 200, the STAs 3, 5, 6, 7 may have additional data to transmit. The AP 104 may transmit a third trigger frame 224 within the TXOP 210 to the STAs 3, 5, 6, 7. In an aspect, the STAs 3, 5, 6, 7 may be allocated resources on the same respective frequencies as indicated in the second trigger frame 218, or the STAs 3, 5, 6, 7 may be allocated resources on different frequencies. The third trigger frame 224 may include a third delay indicator set to 0.

Upon receiving the third trigger frame 224, the STAs 3, 5, 6, 7 may transmit a third set of uplink transmissions 226. For example, each of the STAs 3, 5, 6, 7 may transmit an UL BU such that the third set of uplink transmissions 226 includes UL BU 3, UL BU 5, UL BU 7, and UL BU 6, corresponding to STAs 3, 5, 7, 6, respectively. Upon receiving the UL BU 3, 5, 6, 7, the AP 104 may determine when to transmit a control response frame to each of the STAs 3, 5, 6, 7. In an aspect, the determination may be based on the third delay indicator. In this example, the third delay indicator may be set to 0, which may indicate that the AP 104 may not delay transmitting the control response frames, and therefore, the AP 104 may transmit control response frames within a SIFS after receiving an uplink frames.

Referring to diagram 200, instead of transmitting a BA or an ACK frame, the AP 104 may transmit a first multi-station block acknowledgment (M-BA) frame 228.

An M-BA frame may include acknowledgment information for multiple STAs. In an aspect, the first M-BA frame 228 may include acknowledge information for the STAs 3, 5, 6, 7. The acknowledge information may be associated with identifiers for each of the STAs 3, 5, 6, 7, and the identifiers may be included within the first M-BA frame 228 to enable to STAs 3, 5, 6, 7 to identify its respective acknowledgment information. In an aspect, the first M-BA frame 228 may be transmitted over an entire bandwidth.

As shown in diagram 200, the AP 104 may transmit a control response frame (e.g., an ACK frame, a BA frame, or an M-BA frame) after each uplink transmission. However, not all uplink transmissions may require immediate control frame responses. When the AP 104 immediately transmits control frame responses after every uplink transmission, the AP 104 may create unnecessary congestion and block or reduce medium access. To reduce the amount of overhead due to control response frame transmissions, the AP 104 may manage when control response frames may be sent as shown in diagram 250. A reduction in the number of control response frame transmission may enable greater medium access. For example, more STAs may transmit within the TXOP 210 because the medium will be less congested. Furthermore, delaying control response frame transmission may enable certain STAs to enter a sleep mode because the STAs do not have to wait for the control response frame transmission until a later time, which conserves battery.

Diagram 250 illustrates how the AP 104 may control when to transmit the control response frames. Referring to diagram 250, the STAs 1, 2, 4, 6 may have data to transmit to the AP 104 within the TXOP 210. The STAs 1, 2, 4, 6 may send the AP 104 a request to transmit data. Assuming the AP 104 allows the STAs 1, 2, 4, 6 to transmit, the AP 104 may transmit a fourth trigger frame 252 to each of the STAs 1, 2, 4, 6. The fourth trigger frame 252 may indicate resources that have been allocated to each of the STAs 1, 2, 4, 6 for uplink transmission. In an aspect, the fourth trigger frame 252 may include a fourth delay indicator set to 1. As such, the fourth delay indicator may indicate that the AP 104 may transmit the downlink control response frame at the end of the TXOP 210 or after there is no more data to be sent during the TXOP 210. As such, the fourth delay indicator indicates that the AP 104 may delay transmitting the downlink control response frame (e.g., transmit after a SIFS).

Upon receiving the fourth trigger frame 252, the STAs 1, 2, 4, 6 may transmit a fourth set of uplink transmissions 254. For example, each of the STAs 1, 2, 4, 6 may transmit an uplink BU such that the fourth set of uplink transmissions 254 includes UL BU 1, UL BU 2, UL BU 4, and UL BU 6, corresponding to STAs 1, 2, 4, 6, respectively. Upon receiving the UL BU 1, 2, 4, 6, the AP 104 may determine when to transmit a control response frame to each of the STAs 1, 2, 4, 6. In an aspect, the determination may be based on the fourth delay indicator. In this example, the fourth delay indicator may be set to 1, which may indicate that the AP 104 may delay transmitting the control response frames. In this case, the AP 104 may accumulate the acknowledgment information associated with uplink transmissions received during the TXOP 210 and transmit the accumulated acknowledgment information either at the end of the TXOP 210 or when no more data is to be transmitted within the TXOP 210.

Continuing with diagram 250, the STAs 1, 2, 4 may no longer have data to transmit, but the STAs 3, 5, 6, 7 may have data to transmit. The AP 104 may transmit a fifth trigger frame 256 within the TXOP 210 to the STAs 3, 5, 6, 7. In an aspect, the STA 6 may be allocated resources on the same frequencies as indicated in the fourth trigger frame 252, or the STA 6 may be allocated resources on different frequencies. The fifth trigger frame 256 may include a fifth delay indicator set to 1.

Upon receiving the fifth trigger frame 256, the STAs 3, 5, 6, 7 may transmit a fifth set of uplink transmissions 258. For example, each of the STAs 3, 5, 6, 7 may transmit an UL BU such that the fifth set of uplink transmissions 258 includes UL BU 3, UL BU 5, UL BU 7, and UL BU 6, corresponding to STAs 3, 5, 7, 6, respectively. Upon receiving the UL BU 3, 5, 6, 7, the AP 104 may determine when to transmit a control response frame to each of the STAs 3, 5, 6, 7. In an aspect, the determination may be based on the fifth delay indicator. In this example, the fifth delay indicator may be set to 1, which may indicate that the AP 104 may delay transmitting an acknowledgment to the UL BUs.

Continuing with diagram 250, the STAs 3, 5, 6, 7 may have additional data to transmit. The AP 104 may transmit a sixth trigger frame 260 within the TXOP 210 to the STAs 3, 5, 6, 7. In an aspect, the STAs 3, 5, 6, 7 may be allocated resources on the same respective frequencies as indicated in the fifth trigger frame 256, or the STAs 3, 5, 6, 7 may be allocated resources on different frequencies. The sixth trigger frame 260 may include a sixth delay indicator set to 0. In this aspect, the sixth delay indicator may be set to 0 because the STAs 3, 5, 6, 7 may have indicated that the STAs 3, 5, 6, 7 each have one more frame left to transmit in the TXOP 210.

Upon receiving the sixth trigger frame 260, the STAs 3, 5, 6, 7 may transmit a sixth set of uplink transmissions 262. For example, each of the STAs 3, 5, 6, 7 may transmit an UL BU such that the sixth set of uplink transmissions 262 includes UL BU 3, UL BU 5, UL BU 7, and UL BU 6, corresponding to STAs 3, 5, 7, 6, respectively. Upon receiving the UL BU 3, 5, 6, 7, the AP 104 may determine when to transmit a control response frame to each of the STAs 3, 5, 6, 7. In an aspect, the determination may be based on the sixth delay indicator. In this example, the sixth delay indicator may be set to 0, which may indicate that the AP 104 may not delay transmitting the control response frames, and therefore, the AP 104 may transmit a second M-BA frame 264 within a SIFS after receiving the sixth set of uplink transmissions 262. In an aspect, the second M-BA frame 264 may include accumulated acknowledgment information associated with the fourth, fifth, and sixth sets of uplink transmissions 254, 258, 262. For example, as shown in FIG. 2, the second M-BA frame 264 may include acknowledgment information from the first set of control response frames 216, the second set of control response frames 222, and the first M-BA frame 228.

In another aspect, the second M-BA frame 264 may not be sent SIFS after the sixth set of uplink transmissions. Instead, the second M-BA frame 264 may be sent at the end of the TXOP 210 as denoted by the second M-BA frame 264′ in diagram 250, for example, if the sixth delay indicator is set to 1.

In another aspect, STAs may sleep for a remaining portion of the TXOP 210 if both the AP 104 and the STA (e.g., the STAs 1, 2, 4) have indicated that there is no DL or UL data to transmit (e.g., more data bits in the frame control fields of the frames from the AP and from the STAs set to 0; if additional data is to be sent, the more data bit may be set to 1). For example, the STA 1 may sleep for an interval 270 within the TXOP 210 if the AP 104 and the STA 1 have respectively indicated that the AP 104 does not contain any DL BUs for the STA 1 and the STA 1 does not have any UL BUs for the AP 104. The AP 104 and the STA 1 may indicate that no BUs remain by setting a respective more data bit to 0. In this aspect, the STA 1 may wake up early enough to receive the second M-BA frame 264′. The interval 270 may be determined by identifying a time at which the TXOP 210 ends. The STA 1 may determine when the TXOP 210 ends based on when the TXOP 210 begins and the time duration of the TXOP 210. The STA 1 may subtract a maximum length or time duration for the second M-BA frame 264′ (e.g., 160 μs for an M-BA that includes information for 16 STAs) from the time at which the TXOP 210 ends. In an aspect, the STA 1 may further subtract a SIFS (or some other IFS) from the difference to provide a time buffer to ensure that the STA 1 wakes up before when the second M-BA frame 264′ is transmitted. As such, the interval 270 may start from when the STA 1 finishes transmitting (or finishes receiving) and extend or last until a SIFS before the longest M-BA may be transmitted before the end of the TXOP 210.

In another configuration, the AP 104 may determine whether to delay transmitting a control response frame based on a priority level of the transmission from the STA. In one example, if the STA transmits data or control information transmission that requires an immediate acknowledgment, then the AP 104 may determine not to delay transmitting the control response frame. In another example, the STA may include with the UL BU transmission an indication of whether acknowledgment may be delayed. The AP 104 may delay transmitting the control response frame if the STA indicates control response transmission may be delayed; otherwise, if the STA requests immediate acknowledgment, then the AP 104 may not delay the transmission of the control response frame. In another configuration, the AP 104 may determine whether to delay transmitting a control response based on a priority level associated with the STAs. For example, if at least one STA in a group of STAs sending an MU transmission has a high priority, then the AP 104 may determine not to delay sending the control response frame. Otherwise, the AP 104 may delay transmitting the control response frame.

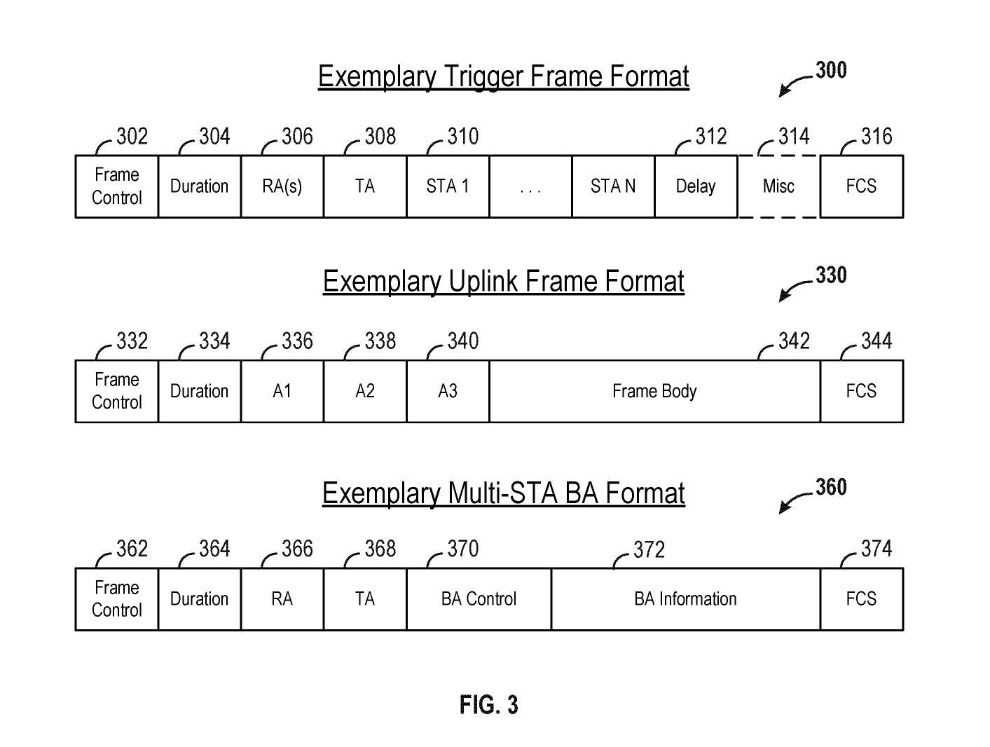

FIG. 3 illustrates exemplary diagrams of a trigger frame 300 that indicates whether a control response frame is to be delayed, an uplink frame 330, and a multi-station block acknowledgment frame 360. Referring to FIG. 3, the trigger frame 300 may include a frame control field 302, a duration field 304, a receive address field 306, a transmit address field 308, a STA field 310, a delay field 312, a miscellaneous field 314, and a frame check sequence (FCS) field 316. The frame control field 302 may include subfields related to control information for the trigger frame 300. For example, the frame control field 302 may have a more data subfield that the AP 104 may use to indicate to a STA if there is additional data for transmission (e.g., more data set to 1) or if there is no more data for transmission (e.g., more data set to 0) within a TXOP. The duration field 304 is used to indicate the duration of the trigger frame 300 (e.g., a duration in microseconds). The receive address field 306 may include one or more addresses of the intended recipients of the trigger frame 300. For example, referring to FIG. 2, if the trigger frame 300 is the fourth trigger frame, then the receive address field 306 may include the addresses of the STAs 1, 2, 4, 6. In another aspect, the receive address field 306 may include a broadcast address to which all STAs listen. The transmit address field 308 may include the address of the AP 104. The STA field 310 may include one or more STA IDs corresponding to the STAs to which the trigger frame 300 is addressed. For example, if the receive address field 306 includes a common broadcast address, then the STA field 310 may indicate specific STAs for which the trigger frame 300 is intended. In another configuration, the STA field 310 may also include STA-specific information such as an uplink resource allocation for a particular STA, power control information, MCS, a number of spatial streams, target received power, etc. The delay field 312 may include a bit indicating whether the AP 104 will delay transmitting the control response frame. In an aspect, the delay field 312 may be known as a cascade field. In another aspect, the delay field may be a subfield within any other existing field of the trigger frame 300. The miscellaneous field 314 may correspond to one or more other fields in the trigger frame 300. In one configuration, the miscellaneous field 314 may include information common to all STAs triggered for uplink transmission. For example, miscellaneous field 314 may include the delay indicator if there is not a separate delay field. In another example, if the control response frame is delayed, the miscellaneous field 314 may indicate when the control response will be transmitted.

Referring to FIG. 3, the uplink frame 330 may include a frame control field 332, a duration field 334, one or more address fields 336, 338, 340, a frame body 342, and an FCS field 344. The multi-station block acknowledgment frame 360 may include a frame control field 362, a duration field 364, a receive address field 366, a transmit address field 368, a block acknowledgment control field 370, a block acknowledgment information field 372, and an FCS field 374. In an aspect, the block acknowledgment information field 372 may indicate one or more stations for which accumulated acknowledgment information is available. Further, the block acknowledgment information field 372 may include acknowledgment information associated with one or more uplink transmissions received, successfully or unsuccessfully, from the one or more stations.

The foregoing frame structures for the trigger frame 300, the uplink frame 330, and the multi-station block acknowledgment frame 360 are exemplary, and other frame structures may also be used.

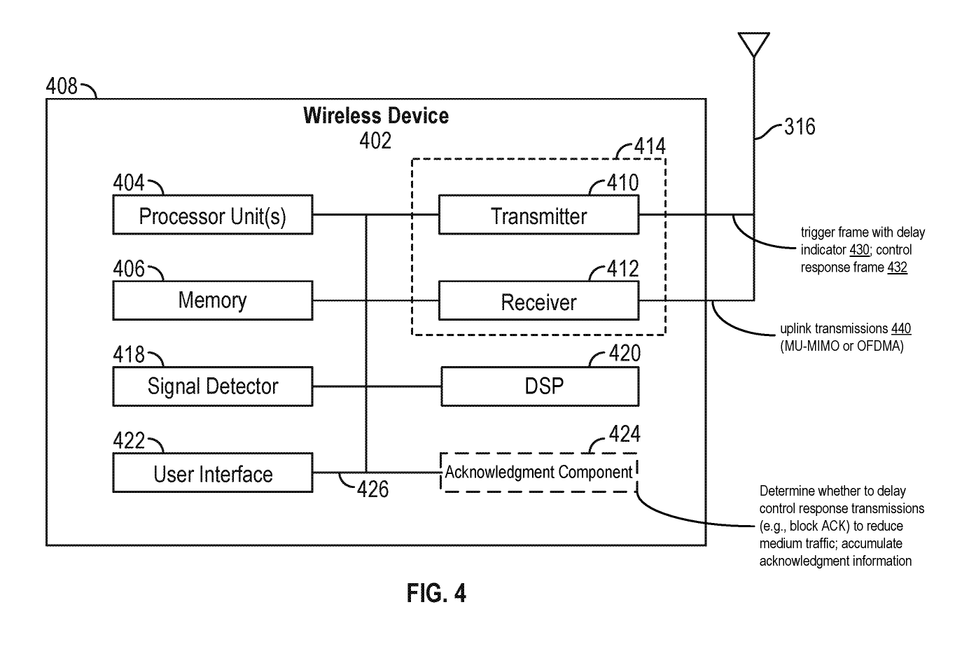

FIG. 4 is a functional block diagram of a wireless device 402 that may be employed within the wireless communication system 100 of FIG. 1 to allocate dedicated single stream pilots for phase tracking. The wireless device 402 is an example of a device that may be configured to implement the various methods described herein. For example, the wireless device 402 may be the AP 104 or the AP 202.

The wireless device 402 may include a processor 404 which controls operation of the wireless device 402. The processor 404 may also be referred to as a central processing unit (CPU). Memory 406, which may include both read-only memory (ROM) and random access memory (RAM), may provide instructions and data to the processor 404. A portion of the memory 406 may also include non-volatile random access memory (NVRAM). The processor 404 typically performs logical and arithmetic operations based on program instructions stored within the memory 406. The instructions in the memory 406 may be executable (by the processor 404, for example) to implement the methods described herein.

The processor 404 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 402 may also include a housing 408, and the wireless device 402 may include a transmitter 410 and/or a receiver 412 to allow transmission and reception of data between the wireless device 402 and a remote device. The transmitter 410 and the receiver 412 may be combined into a transceiver 414. An antenna 416 may be attached to the housing 408 and electrically coupled to the transceiver 414. The wireless device 402 may also include multiple transmitters, multiple receivers, multiple transceivers, and/or multiple antennas.

The wireless device 402 may also include a signal detector 418 that may be used to detect and quantify the level of signals received by the transceiver 414 or the receiver 412. The signal detector 418 may detect such signals as total energy, energy per subcarrier per symbol, power spectral density, and other signals. The wireless device 402 may also include a DSP 420 for use in processing signals. The DSP 420 may be configured to generate a packet for transmission. In some aspects, the packet may comprise a physical layer convergence protocol (PLCP) protocol data unit (PPDU).

The wireless device 402 may further comprise a user interface 422 in some aspects. The user interface 422 may comprise a keypad, a microphone, a speaker, and/or a display. The user interface 422 may include any element or component that conveys information to a user of the wireless device 402 and/or receives input from the user.

When the wireless device 402 is implemented as an AP (e.g., AP 104), the wireless device 402 may also comprise an acknowledgment component 424. The acknowledgment component 424 may be configured to transmit a first frame (e.g., a trigger frame 430 or a clear to send frame in a request to send/clear to send frame exchange between two devices) that includes a delay indicator. The acknowledgment component 424 may be configured to receive a second frame (e.g., uplink transmissions 440) from a station based on the transmitted first frame. The acknowledgment component 424 may be configured to determine when to transmit a third frame (e.g., a control response frame 432, a multi-STA BA frame, or a block acknowledgment frame) based on the received second frame. The delay indicator may indicate whether the wireless device 402 will delay transmitting the third frame after receiving the second frame during multi-user uplink operation. In an aspect, the delay indicator may be a bit indicator that indicates when the wireless device 402 will transmit the third frame. In another aspect, the delay indicator indicates whether the wireless device 402 will transmit the third frame within an interframe space after receiving the second frame. In another aspect, the delay indicator may indicate whether the wireless device 402 will transmit the third frame at an end of a transmit opportunity for multi-user uplink transmissions for a plurality of stations. In another aspect, the first frame may be a trigger frame, the second frame may be an uplink frame, and the third frame may be a multi-station block acknowledgment frame. In another configuration, the acknowledgment component 424 may be configured to receive a plurality of frames from a plurality of stations. In this configuration, the acknowledgment component 424 may be configured to accumulate acknowledgment information associated with the plurality of frames from the plurality of stations and with the second frame from the station. The acknowledgment component 424 may be configured to transmit the third frame based on the determination of when to transmit the third frame. The third frame may include the accumulated acknowledgment information and the determination may be further based on the received plurality of frames.

The various components of the wireless device 402 may be coupled together by a bus system 426. The bus system 426 may include a data bus, for example, as well as a power bus, a control signal bus, and a status signal bus in addition to the data bus. Components of the wireless device 402 may be coupled together or accept or provide inputs to each other using some other mechanism.

Although a number of separate components are illustrated in FIG. 4, one or more of the components may be combined or commonly implemented. For example, the processor 404 may be used to implement not only the functionality described above with respect to the processor 404, but also to implement the functionality described above with respect to the signal detector 418, the DSP 420, the user interface 422, and/or the acknowledgment component 424. Further, each of the components illustrated in FIG. 4 may be implemented using a plurality of separate elements.

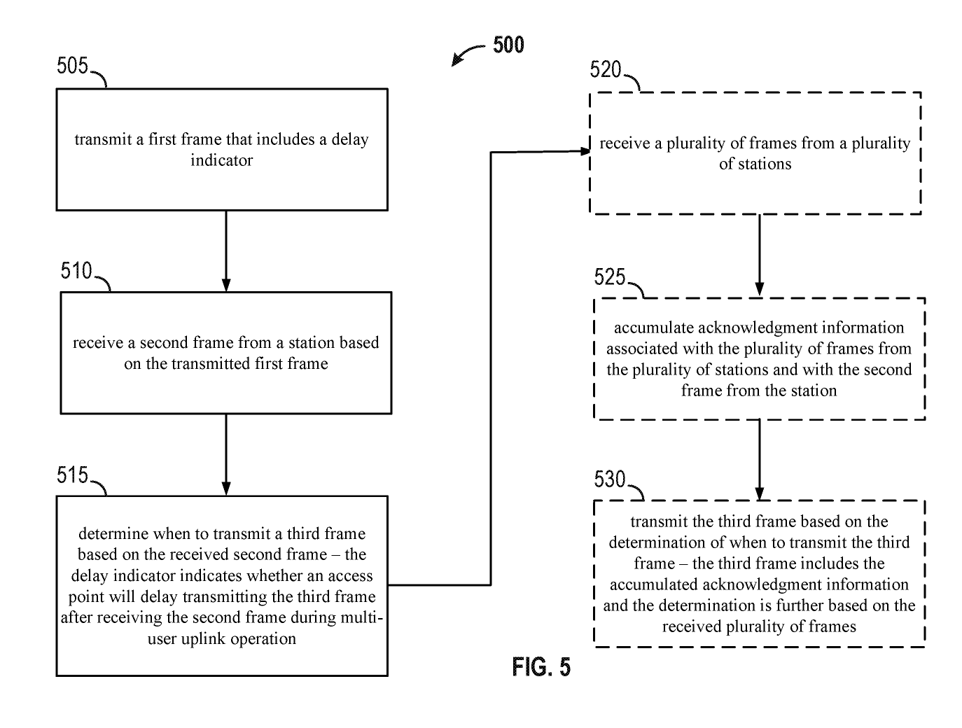

FIG. 5 is a flowchart of an exemplary method 500 of wireless communication for controlling responses to uplink multi-user frames. The method 500 may be performed using an apparatus (e.g., the AP 104, or the wireless device 402, for example). Although the method 500 is described below with respect to the elements of wireless device 402 of FIG. 4, other components may be used to implement one or more of the steps described herein. As shown in FIG. 5, blocks with dotted lines represent optional operations.

At block 505, the apparatus may transmit a first frame that includes a delay indicator. For example, referring to FIGS. 1 and 2, the apparatus may be the AP 104. The AP 104 may transmit the fourth trigger frame 252 that may include the fourth delay indicator.

At block 510, the apparatus may receive a second frame based on the transmitted first frame. For example, referring to FIGS. 1 and 2, the AP 104 may receive the UL BU 1 from the STA 1 based on the fourth trigger frame 252 transmitted to the STA 1.

At block 515, the apparatus may determine when to transmit a third frame based on the received second frame. The delay indicator may indicate whether the apparatus will delay transmitting the third frame after receiving the second frame during multi-user uplink operation. For example, referring to FIGS. 1 and 2, the AP 104 may determine when to transmit the second M-BA frame 264 (the third frame) based on the received UL BU 1. If the fourth delay indicator is set to 1, the AP 104 may determine to delay transmitting the second M-BA frame 264 after receiving the UL BU 1 during multi-user uplink operation within the TXOP 210. By contrast, if the fourth delay indicator is set to 0, the AP 104 may determine not to delay transmitting the second M-BA frame 264 (or some other acknowledgment frame), and may transmit the second M-BA frame 264 a SIFS after receiving the UL BU 1. The AP 104 may determine whether to delay transmitting an acknowledgment frame based on the amount of uplink traffic available and the amount of downlink traffic available. If the amount of uplink and/or downlink traffic is above a threshold, the AP 104 may determine to delay transmitting an acknowledgment message in order to increase throughput. By contrast, if the amount of uplink and/or downlink traffic is below a threshold, the AP 104 may determine not to delay transmitting the acknowledgment message.

At block 520, the apparatus may receive a plurality of frames from a plurality of stations. For example, referring to FIGS. 1 and 2, the AP 104 may receive UL BUs 2, 4, and 6 from the fourth set of uplink transmissions 254, receive UL BUs 3, 5, 7, 6 from the fifth set of uplink transmissions 258, and receive UL Bus 3, 5, 7, 6, from the sixth set of uplink transmissions 262 (the plurality of frames) from STAs 2, 4, STA 6, 3, 5, 7 (the plurality of stations).

At block 525, the apparatus may accumulate acknowledgment information associated with the plurality of frames from the plurality of stations and with the second frame from the station. For example, referring to FIGS. 1 and 2, the AP 104 may determine whether each of the UL BUs in the fourth, fifth, and sixth sets of uplink transmissions 254, 258, 262 was successfully received. Then, the AP 104 may store information related to the determination for subsequent transmission.

At block 530, the apparatus may transmit the third frame based on the determination of when to transmit the third frame. The third frame may include the accumulated acknowledgment information and the determination may be further based on the received plurality of frames. For example, referring to FIGS. 1 and 2, the AP 104 may transmit the second M-BA frame 264 (the third frame) based on the determination to delay transmitting the second M-BA frame 264 until the end of the TXOP 210. The second M-BA frame 264 may include the accumulated acknowledgment information associated with the UL BUs from the fourth, fifth, and sixth sets of uplink transmissions 254, 258, 262. The AP 104 may determine to transmit the second M-BA frame 264 either at the end of the TXOP 210 or after knowing that there is no more downlink or uplink BUs.

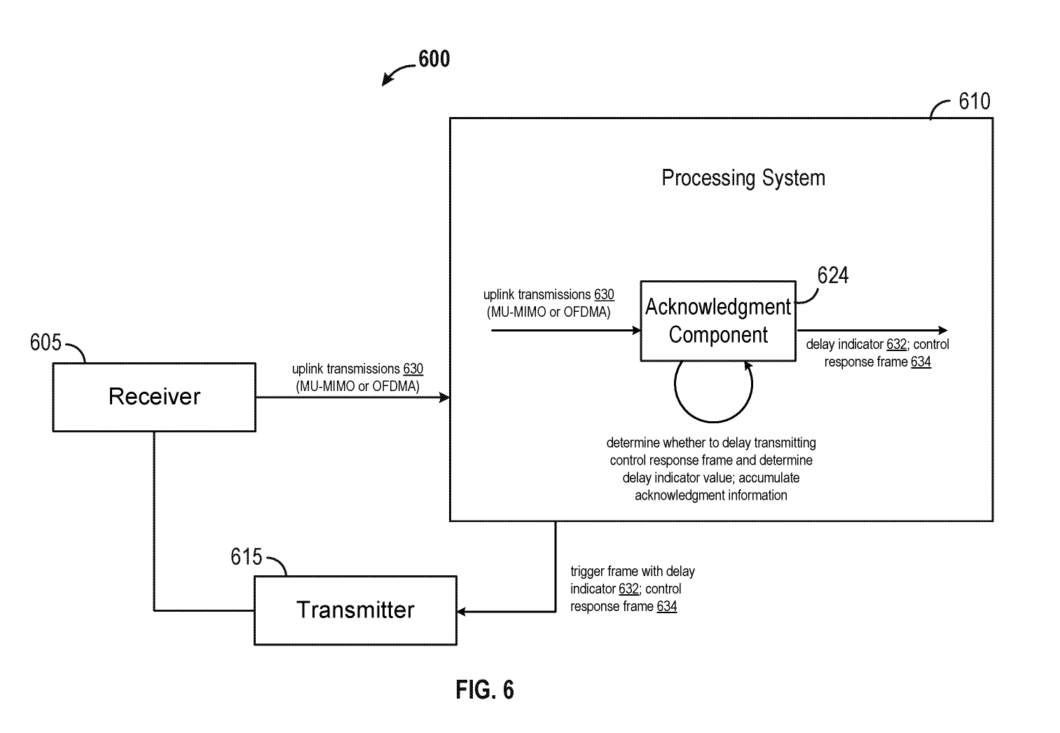

FIG. 6 is a functional block diagram of an exemplary wireless communication device 600 that controls responses to uplink multi-user frames. The wireless communication device 600 may include a receiver 605, a processing system 610, and a transmitter 615. The processing system 610 may include an acknowledgment component 624. The transmitter 615, the processing system 610, and/or the acknowledgment component 624 may be configured to transmit a first frame (e.g., a trigger frame 632) that includes a delay indicator. The receiver 605, the processing system 610, and/or the acknowledgment component 624 may be configured to receive a second frame (e.g., uplink transmissions 630) from a station based on the transmitted first frame. The processing system 610 and/or the acknowledgment component 624 may be configured to determine when to transmit a third frame (e.g., a control response frame 634 or a multi-station block acknowledgment) based on the received second frame. The delay indicator may indicate whether the wireless communication device 600 will delay transmitting the third frame after receiving the second frame during multi-user uplink operation. In an aspect, the delay indicator may be a bit indicator that indicates when the wireless communication device 600 will transmit the third frame. In another aspect, the delay indicator indicates whether the wireless communication device 600 will transmit the third frame within an interframe space after receiving the second frame. In another aspect, the delay indicator may indicate whether the wireless communication device 600 will transmit the third frame at an end of a transmit opportunity for multi-user uplink transmissions for a plurality of stations. In another aspect, the first frame may be a trigger frame, the second frame may be an uplink frame, and the third frame may be a multi-station block acknowledgment frame. In another configuration, the receiver 605, the processing system 610, and/or the acknowledgment component 624 may be configured to receive a plurality of frames from a plurality of stations. In this configuration, the processing system 610 and/or the acknowledgment component 624 may be configured to accumulate acknowledgment information associated with the plurality of frames from the plurality of stations and with the second frame from the station. The transmitter 615, the processing system 610, and/or the acknowledgment component 624 may be configured to transmit the third frame based on the determination of when to transmit the third frame. The third frame may include the accumulated acknowledgment information and the determination may be further based on the received plurality of frames.

The receiver 605, the processing system 610, the acknowledgment component 624, and/or the transmitter 615 may be configured to perform one or more functions discussed above with respect to blocks 505, 510, 515, 520, 525, and 530 of FIG. 5. The receiver 605 may correspond to the receiver 412. The processing system 610 may correspond to the processor 404. The transmitter 615 may correspond to the transmitter 410. The acknowledgment component 624 may correspond to the acknowledgment component 124 and/or the acknowledgment component 424.

In one configuration, the wireless communication device 600 may include means for transmitting a first frame that includes a delay indicator. The wireless communication device 600 may include means for receiving a second frame from a station based on the transmitted first frame. The wireless communication device 600 may include means for determining when to transmit a third frame based on the received second frame. The delay indicator may indicate whether the wireless communication device 600 will delay transmitting the third frame after receiving the second frame during multi-user uplink operation. In an aspect, the delay indicator may be a bit indicator that indicates when the wireless communication device 600 will transmit the third frame. In another aspect, the delay indicator may indicate whether the wireless communication device 600 will transmit the third frame within an interframe space after receiving the second frame. In another aspect, the delay indicator may indicate whether the wireless communication device 600 will transmit the third frame at an end of a transmit opportunity for multi-user uplink transmissions for a plurality of stations. In another aspect, the first frame may be a trigger frame, the second frame may be an uplink frame, and the third frame may be a multi-station block acknowledgment frame. In another configuration, the wireless communication device 600 may include means for receiving a plurality of frames from a plurality of stations. In this configuration, the wireless communication device 600 may include means for accumulating acknowledgment information associated with the plurality of frames from the plurality of stations and with the second frame from the station. The wireless communication device 600 may include means for transmitting the third frame based on the determination of when to transmit the third frame. The third frame may include the accumulated acknowledgment information and the determination may be further based on the received plurality of frames.

For example, means for transmitting a first frame may include the processing system 610, the acknowledgment component 624, and/or the transmitter 615. Means for receiving a second frame may include the receiver 605, the processing system 610, and/or the acknowledgment component 624. Means for determining when to transmit a third frame may include the processing system 610 and/or the acknowledgment component 624. Means for receiving a plurality of frames may include the receiver 605, the processing system 610, and/or the acknowledgment component 624. Means for accumulating acknowledgment information may include the processing system 610 and/or the acknowledgment component 624. Means for transmitting the third frame may include the transmitter 615, the processing system 610, and/or the acknowledgment component 624.

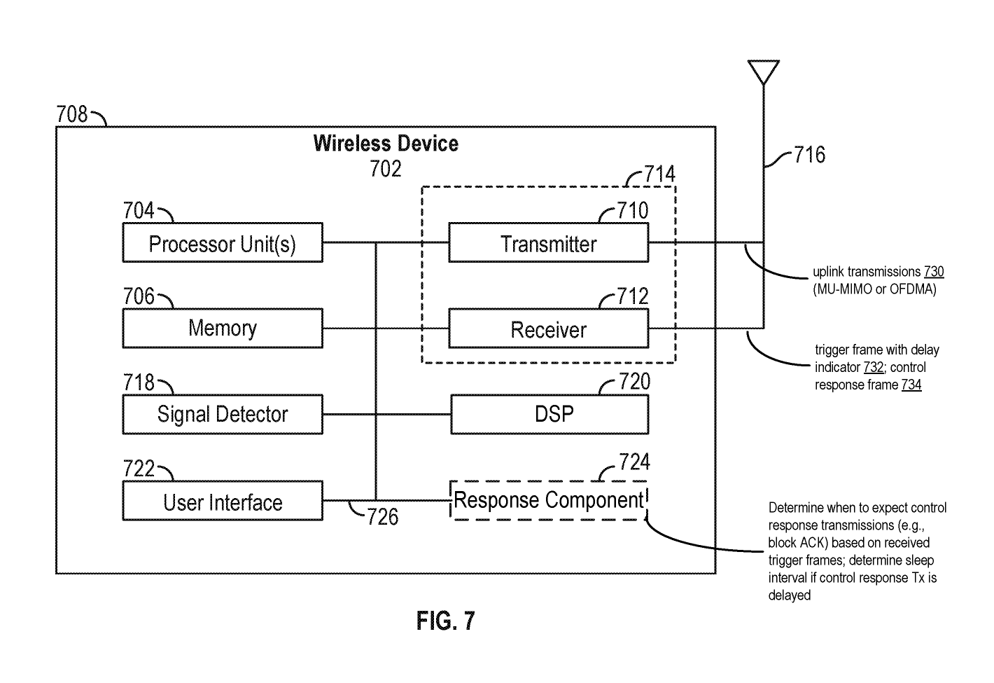

FIG. 7 is a functional block diagram of a wireless device 702 that may be employed within the wireless communication system 100 of FIG. 1 that supports controlled responses to uplink multi-user frames. The wireless device 702 is an example of a device that may be configured to implement the various methods described herein. For example, the wireless device 702 may be the STA 114.

The wireless device 702 may include a processor 704 which controls operation of the wireless device 702. The processor 704 may also be referred to as a CPU. Memory 706, which may include both ROM and RAM, may provide instructions and data to the processor 704. A portion of the memory 706 may also include NVRAM. The processor 704 typically performs logical and arithmetic operations based on program instructions stored within the memory 706. The instructions in the memory 706 may be executable (by the processor 704, for example) to implement the methods described herein.

The processor 704 may comprise or be a component of a processing system implemented with one or more processors. The one or more processors may be implemented with any combination of general-purpose microprocessors, microcontrollers, DSPs, FPGAs, PLDs, controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 702 may also include a housing 708, and the wireless device 702 may include a transmitter 710 and/or a receiver 712 to allow transmission and reception of data between the wireless device 702 and a remote device. The transmitter 710 and the receiver 712 may be combined into a transceiver 714. An antenna 716 may be attached to the housing 708 and electrically coupled to the transceiver 714. The wireless device 702 may also include multiple transmitters, multiple receivers, multiple transceivers, and/or multiple antennas.

The wireless device 702 may also include a signal detector 718 that may be used to detect and quantify the level of signals received by the transceiver 714 or the receiver 712. The signal detector 718 may detect such signals as total energy, energy per subcarrier per symbol, power spectral density, and other signals. The wireless device 702 may also include a DSP 720 for use in processing signals. The DSP 720 may be configured to generate a packet for transmission. In some aspects, the packet may comprise a PPDU.

The wireless device 702 may further comprise a user interface 722 in some aspects. The user interface 722 may comprise a keypad, a microphone, a speaker, and/or a display. The user interface 722 may include any element or component that conveys information to a user of the wireless device 702 and/or receives input from the user.

When the wireless device 702 is implemented as an STA (e.g., STA 114), the wireless device 702 may also include a response component 724. The response component 724 may be configured to receive a first frame (e.g., a trigger frame 732) from an access point that may include a delay indicator. The response component 724 may be configured to transmit a second frame (e.g., uplink transmissions 730) based on the received first frame. The response component 724 may be configured to determine when the access point will transmit a third frame (e.g., a control response frame 734 or a multi-station block acknowledgment) in response to the transmitted second frame. The delay indicator may indicate whether the access point will delay transmitting the third frame after receiving the second frame during multi-user uplink operation. In an aspect, the delay indicator may be a bit indicator that indicates when the access point will transmit the third frame. In another aspect, the delay indicator may indicate whether the access point will transmit the third frame within an interframe space after receiving the second frame. In another aspect, the delay indicator may indicate whether the access point will transmit the third frame at an end of a transmit opportunity for multi-user uplink transmissions for a plurality of stations. In another configuration, the response component 724 may be configured to determining a sleep interval associated with the wireless device 702 based on the delay indicator. The response component 724 may be configured to determine the sleep interval by determining a transmit opportunity time duration associated with multi-user uplink transmissions and by determining a multi-station block acknowledgement time duration. In this configuration, the sleep interval may be based on the transmit opportunity time duration, the multi-station block acknowledgment time duration, and an interframe space time duration. In another aspect, the first frame may be a trigger frame, the second frame may be an uplink frame, and the third frame may be a multi-station block acknowledgment frame.

The various components of the wireless device 702 may be coupled together by a bus system 726. The bus system 726 may include a data bus, for example, as well as a power bus, a control signal bus, and a status signal bus in addition to the data bus. Components of the wireless device 702 may be coupled together or accept or provide inputs to each other using some other mechanism.

Although a number of separate components are illustrated in FIG. 7, one or more of the components may be combined or commonly implemented. For example, the processor 704 may be used to implement not only the functionality described above with respect to the processor 704, but also to implement the functionality described above with respect to the signal detector 718, the DSP 720, the user interface 722, and/or the response component 724. Further, each of the components illustrated in FIG. 7 may be implemented using a plurality of separate elements.

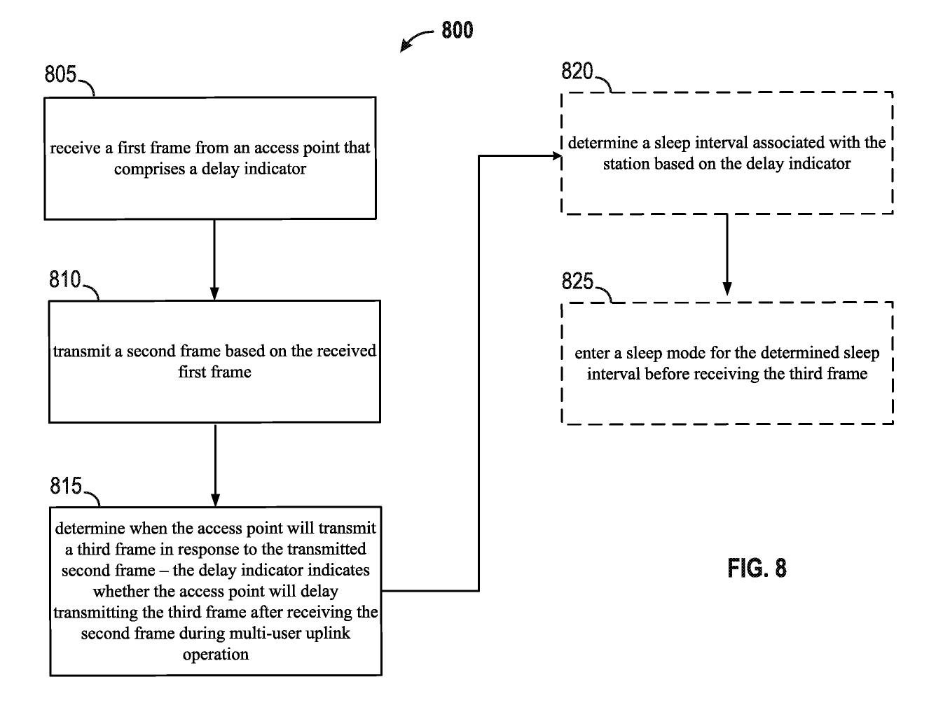

FIG. 8 is a flowchart of an example method 800 of wireless communication for transmitting dedicated single stream pilot for phase tracking. The method 800 may be performed using an apparatus (e.g., the STA 114, or the wireless device 702, for example). Although the method 800 is described below with respect to the elements of wireless device 702 of FIG. 7, other components may be used to implement one or more of the steps described herein. In an aspect, blocks with dotted lines indicate an optional operation.

At block 805, the apparatus may receive a first frame from an access point that includes a delay indicator. For example, referring to FIGS. 1 and 2, the apparatus may be the STA 1. The STA 1 may receive the fourth trigger frame 252 from the AP 104 that includes the fourth delay indicator.

At block 810, the apparatus may transmit a second frame based on the received first frame. For example, referring to FIGS. 1 and 2, the STA 1 may transmit an UL BU 1 (e.g., in the fourth set of uplink transmissions 254) based on the fourth trigger frame 252.

At block 815, the apparatus may determine when the access point will transmit a third frame in response to the transmitted second frame. The delay indicator may indicate whether the access point will delay transmitting the third frame after receiving the second frame during multi-user uplink operation. For example, referring to FIGS. 1 and 2, the STA 1 may determine when the AP 104 will transmit the second M-BA frame 264 (or another acknowledgment frame) in response to the UL BU 1. Because the fourth delay indicator is set to 1, the fourth delay indicator may indicate that the AP 104 will delay transmitting the second M-BA frame 264 until there are no more UL or DL BUs or until the end of the TXOP 210. If the fourth delay indicator was set to 0, then the fourth delay indicator may indicate that the AP 104 will send the second M-BA frame 264 a SIFS after receiving the UL BU.

At block 820, the apparatus may determine a sleep interval associated with the station based on the delay indicator. In one configuration, the apparatus may determine the sleep interval by determining a transmit opportunity time duration associated with MU UL transmissions and by determining an M-BA time duration. In this configuration, the sleep duration may be based on the transmit opportunity time duration, the M-BA time duration, and an IFS time duration. For example, referring to FIGS. 1 and 2, the STA 1 may determine the interval 270 associated with the STA 1 based on the fourth delay indicator. The STA 1 may determine the interval 270 by determine the TXOP 210 time duration, by determining a maximum M-BA time duration (e.g., 160 μs), and by determining a duration of a SIFS (or of another IFS). The interval 270 may start from when the STA 1 has no more data to transmit and may end at time T, where T may be determined based on when the TXOP 210 ends, minus the M-BA time duration (160 μs), and minus the SIFS time duration.

At block 825, the apparatus may enter a sleep mode for the determined sleep interval before receiving the third frame. For example, referring to FIGS. 1 and 2, the STA 1 may sleep for the interval 270. Subsequently, the STA 1 may wake up to receive the second M-BA frame 264.

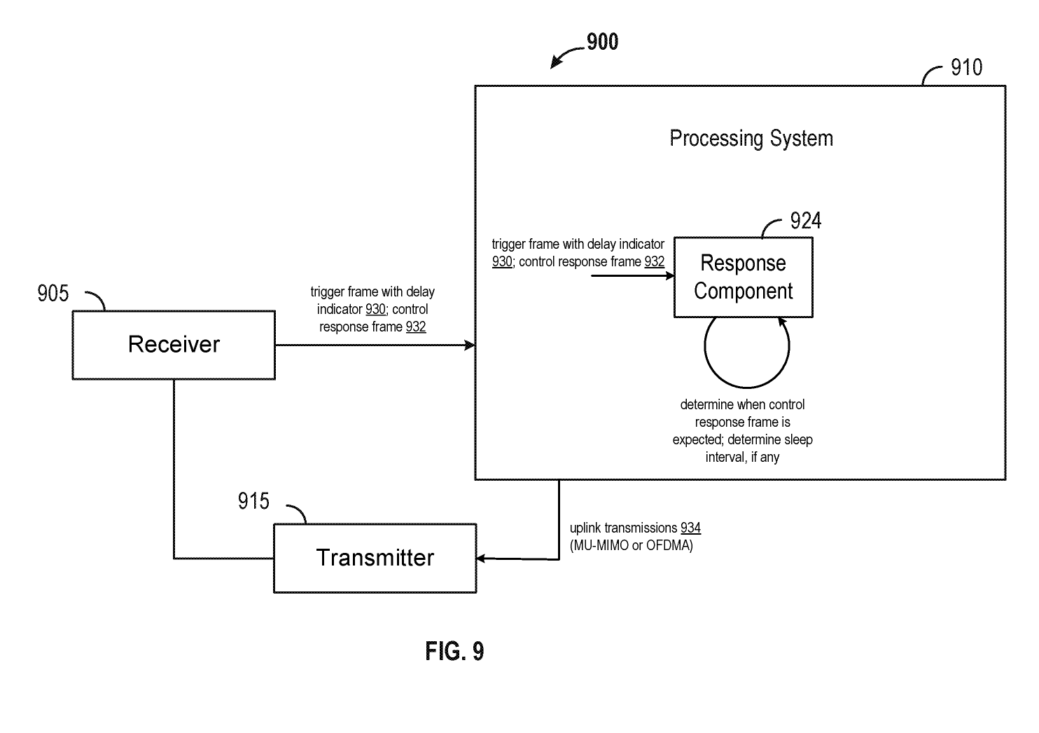

FIG. 9 is a functional block diagram of an exemplary wireless communication device 900 that supports controlled responses to uplink multi-user frames. The wireless communication device 900 may include a receiver 905, a processing system 910, and a transmitter 915. The processing system 910 may include a response component 924. The receiver 905, the processing system 910, and/or the response component 924 may be configured to receive a first frame (e.g., a trigger frame 930) from an access point that may include a delay indicator. The transmitter 915, the processing system 910, and/or the response component 924 may be configured to transmit a second frame (e.g., uplink transmissions 934) based on the received first frame. The processing system 910 and/or the response component 924 may be configured to determine when the access point will transmit a third frame (e.g., a control response frame 932 or a multi-station block acknowledgment) in response to the transmitted second frame. The delay indicator may indicate whether the access point will delay transmitting the third frame after receiving the second frame during multi-user uplink operation. In an aspect, the delay indicator may be a bit indicator that indicates when the access point will transmit the third frame. In another aspect, the delay indicator may indicate whether the access point will transmit the third frame within an interframe space after receiving the second frame. In another aspect, the delay indicator may indicate whether the access point will transmit the third frame at an end of a transmit opportunity for multi-user uplink transmissions for a plurality of stations. In another configuration, the processing system 910 and/or the response component 924 may be configured to determine a sleep interval associated with the wireless device 902 based on the delay indicator. The processing system 910 and/or the response component 924 may be configured to determine the sleep interval by determining a transmit opportunity time duration associated with multi-user uplink transmissions and by determining a multi-station block acknowledgement time duration. In this configuration, the sleep interval may be based on the transmit opportunity time duration, the multi-station block acknowledgment time duration, and an interframe space time duration. In another aspect, the first frame may be a trigger frame, the second frame may be an uplink frame, and the third frame may be a multi-station block acknowledgment frame.

The receiver 905, the processing system 910, the response component 924, and/or the transmitter 915 may be configured to perform one or more functions discussed above with respect to blocks 805, 810, 815, and 820 of FIG. 8. The receiver 905 may correspond to the receiver 712. The processing system 910 may correspond to the processor 704. The transmitter 915 may correspond to the transmitter 710. The response component 924 may correspond to the response component 126 and/or the response component 724.

In one configuration, the wireless communication device 900 may include means for receiving a first frame from an access point that may include a delay indicator. The wireless communication device 900 may include means for transmitting a second frame based on the received first frame. The wireless communication device 900 may include means for determining when the access point will transmit a third frame in response to the transmitted second frame. The delay indicator may indicate whether the access point will delay transmitting the third frame after receiving the second frame during multi-user uplink operation. In an aspect, the delay indicator may be a bit indicator that indicates when the access point will transmit the third frame. In another aspect, the delay indicator may indicate whether the access point will transmit the third frame within an interframe space after receiving the second frame. In another aspect, the delay indicator may indicate whether the access point will transmit the third frame at an end of a transmit opportunity for multi-user uplink transmissions for a plurality of stations. In another configuration, the wireless communication device 900 may include means for determining a sleep interval associated with the wireless device 902 based on the delay indicator. The means for determining the sleep interval may be configured to determine a transmit opportunity time duration associated with multi-user uplink transmissions and to determine a multi-station block acknowledgement time duration. In this configuration, the sleep interval may be based on the transmit opportunity time duration, the multi-station block acknowledgment time duration, and an interframe space time duration. In another aspect, the first frame may be a trigger frame, the second frame may be an uplink frame, and the third frame may be a multi-station block acknowledgment frame.

For example, means receiving a first frame may include the receiver 905, the processing system 910, and/or the response component 924. Means for transmitting a second frame may include the transmitter 915, the processing system 910, and/or the response component 924. Means for determining when the access pint will transmit a third frame may include the processing system 910 and/or the response component 924. Means for determining a sleep interval may include the processing system 910 and/or the response component 924.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an ASIC, an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of wireless communication by an access point, comprising:
transmitting a first frame that comprises a delay indicator;
receiving a second frame from a station based on the transmitted first frame; and
determining when to transmit a third frame based on the received second frame, wherein the delay indicator indicates whether the access point will delay transmitting the third frame after receiving the second frame during multi-user uplink operation.

2. The method of claim 1, wherein the delay indicator is a bit indicator that indicates when the access point will transmit the third frame.

3. The method of claim 1, wherein the delay indicator indicates whether the access point will transmit the third frame within an interframe space after receiving the second frame.

4. The method of claim 1, wherein the delay indicator indicates whether the access point will transmit the third frame at an end of a transmit opportunity for multi-user uplink transmissions for a plurality of stations.

5. The method of claim 1, wherein the first frame is a trigger frame or a clear to send frame, the second frame is an uplink frame, and the third frame is a multi-station block acknowledgment frame or a block acknowledgment frame.

6. The method of claim 1, further comprising:
receiving a plurality of frames from a plurality of stations;
accumulating acknowledgment information associated with the plurality of frames from the plurality of stations and with the second frame from the station; and
transmitting the third frame based on the determination of when to transmit the third frame, wherein the third frame includes the accumulated acknowledgment information and the determination is further based on the received plurality of frames.

7. A method of wireless communication by a station, comprising:
receiving a first frame from an access point that comprises a delay indicator;
transmitting a second frame based on the received first frame; and
determining when the access point will transmit a third frame in response to the transmitted second frame, wherein the delay indicator indicates whether the access point will delay transmitting the third frame after receiving the second frame during multi-user uplink operation.

8. The method of claim 7, wherein the delay indicator is a bit indicator that indicates when the access point will transmit the third frame.

9. The method of claim 7, wherein the delay indicator indicates whether the access point will transmit the third frame within an interframe space after receiving the second frame.

10. The method of claim 7, wherein the delay indicator indicates whether the access point will transmit the third frame at an end of a transmit opportunity for multi-user uplink transmissions for a plurality of stations.

11. The method of claim 7, further comprising:
determining a sleep interval associated with the station based on the delay indicator; and
entering a sleep mode for the determined sleep interval before receiving the third frame.

12. The method of claim 11, wherein the determining the sleep interval comprises:
determining a transmit opportunity time duration associated with multi-user uplink transmissions; and
determining a multi-station block acknowledgement time duration, wherein the sleep interval is based on the transmit opportunity time duration, the multi-station block acknowledgment time duration, and an interframe space time duration.

13. The method of claim 7, wherein the first frame is a trigger frame or a clear to send frame, the second frame is an uplink frame, and the third frame is a multi-station block acknowledgment frame or a block acknowledgment frame.

14. An access point for wireless communication, comprising:
a memory; and
at least one processor coupled to the memory and configured to:
transmit a first frame that comprises a delay indicator;
receive a second frame from a station based on the transmitted first frame; and
determine when to transmit a third frame based on the received second frame, wherein the delay indicator indicates whether the access point will delay transmitting the third frame after receiving the second frame during multi-user uplink operation.

15. The access point of claim 14, wherein the delay indicator is a bit indicator that indicates when the access point will transmit the third frame.

16. The access point of claim 14, wherein the delay indicator indicates whether the access point will transmit the third frame within an interframe space after receiving the second frame.

17. The access point of claim 14, wherein the delay indicator indicates whether the access point will transmit the third frame at an end of a transmit opportunity for multi-user uplink transmissions for a plurality of stations.

18. The access point of claim 14, wherein the first frame is a trigger frame or a clear to send frame, the second frame is an uplink frame, and the third frame is a multi-station block acknowledgment frame or a block acknowledgment frame.

19. The access point of claim 14, wherein the at least one processor is further configured to:
receive a plurality of frames from a plurality of stations;
accumulate acknowledgment information associated with the plurality of frames from the plurality of stations and with the second frame from the station; and
transmit the third frame based on the determination of when to transmit the third frame, wherein the third frame includes the accumulated acknowledgment information and the determination is further based on the received plurality of frames.

20. A station for wireless communication, comprising:
a memory; and
at least one processor coupled to the memory and configured to:
receive a first frame from an access point that comprises a delay indicator;
transmit a second frame based on the received first frame; and
determine when the access point will transmit a third frame in response to the transmitted second frame, wherein the delay indicator indicates whether the access point will delay transmitting the third frame after receiving the second frame during multi-user uplink operation.

21. The station of claim 20, wherein the delay indicator is a bit indicator that indicates when the access point will transmit the third frame.

22. The station of claim 20, wherein the delay indicator indicates whether the access point will transmit the third frame within an interframe space after receiving the second frame.

23. The station of claim 20, wherein the delay indicator indicates whether the access point will transmit the third frame at an end of a transmit opportunity for multi-user uplink transmissions for a plurality of stations.

24. The station of claim 20, wherein the at least one processor is further configured to:
determine a sleep interval associated with the station based on the delay indicator; and
enter a sleep mode for the determined sleep interval before receiving the third frame.

25. The station of claim 24, wherein the at least one processor is configured to determine the sleep interval by:
determining a transmit opportunity time duration associated with multi-user uplink transmissions; and
determining a multi-station block acknowledgement time duration, wherein the sleep interval is based on the transmit opportunity time duration, the multi-station block acknowledgment time duration, and an interframe space time duration.

26. The station of claim 20, wherein the first frame is a trigger frame or a clear to send frame, the second frame is an uplink frame, and the third frame is a multi-station block acknowledgment frame or a block acknowledgment frame.
